(19) United States
(12) Patent Application Publication
(10) Pub. No.: US 2013/0144691 A1
(43) Pub. Date: Jun. 6, 2013

(54) PRODUCT SHOWCASE BASED ADVERTISING SYSTEMS AND METHODS

(71) Applicants: Japan A. Mehta, Coppell, TX (US); Brian F. Roberts, Dallas, TX (US); Anthony M. Lemus, Irving, TX (US); Kishore Tallapaneni, Flower Mound, TX (US); Donald H. Relyea, Dallas, TX (US); Michael R. Oliver, Hoboken, NJ (US)

(72) Inventors: Japan A. Mehta, Coppell, TX (US); Brian F. Roberts, Dallas, TX (US); Anthony M. Lemus, Irving, TX (US); Kishore Tallapaneni, Flower Mound, TX (US); Donald H. Relyea, Dallas, TX (US); Michael R. Oliver, Hoboken, NJ (US)

(73) Assignee: Verizon Patent and Licensing Inc., Basking Ridge, NJ (US)

(21) Appl. No.: 13/308,925

(22) Filed: Dec. 1, 2011

(51) Int. Cl. G06Q 30/02

(52) U.S. Cl. 705/14.4

(57) ABSTRACT

An exemplary method includes a computing system tracking a plurality of product showcase events that showcase one or more products to a user, detecting an advertisement trigger event associated with the user, and, in response to the detecting of the advertisement trigger event, identifying a product associated with both the advertisement trigger event and a product showcase event included in the plurality of product showcase events and notifying the user of the product showcase event that showcased the product. Corresponding methods and systems are also disclosed.

### BACKGROUND INFORMATION

When a user experiences content, such as when media content is presented to a user, the user may be exposed to products and/or services (collectively referred to hereinafter as “products”) showcased by the content. For example, products may be placed in media content such that when the media content is presented to a user, the user is exposed to the products. It is a common practice for advertisers of products to pay media content producers for placement of the products in media content.

When a user is exposed to showcased products, the user may be interested in purchasing, using, and/or learning more about the products. However, conventionally there has been a disconnection between a user being exposed to showcased products and the user actually acting on his or her interest in the products. For example, it is not uncommon for a user to forget about his or her interest in a showcased product after product has been showcased to the user.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary advertising computing system according to principles described herein.

FIGS. 2-3 illustrate exemplary on-screen displays of content that may be provided in relation to tracking product showcase events according to principles described herein.

FIG. 4 illustrates an exemplary product correlation according to principles described herein.

FIG. 5 illustrates an on-screen display of an exemplary notification message and product advertisement according to principles described herein.

FIG. 6 illustrates an exemplary product showcase based advertising method according to principles described herein.

FIG. 7 illustrates an exemplary implementation of the system of FIG. 1 according to principles described herein.

FIG. 8 illustrates an exemplary computing device according to principles described herein.

### DETAILED DESCRIPTION OF PREFERRED EMBODIMENTS

Exemplary product showcase based advertising systems and methods are disclosed herein. In certain exemplary embodiments described herein, a computing system may track product showcase events that showcase one or more products, detect an advertisement trigger event associated with a user, identify a product associated with both the advertisement trigger event and a product showcase event that showcased the product, and notify the user of the product showcase event that showcased the product. The computing system may also facilitate user access to the product showcase event.

To illustrate one example, in certain embodiments, the computing system may track presentations of media content for experiencing by a user. For example, the computing system may generate a media content viewing history for the user. The computing system may then identify one or more products showcased by the media content.

The computing system may be configured to use the identified showcased products to leverage the product showcase events that showcased the products to advertise the products to the user. To this end, the computing system may detect an advertisement trigger event associated with the user. The advertisement trigger event may include any event predefined to trigger performance of one or more advertising operations, such as an operation that presents an advertisement for a product to the user and/or an operation that notifies the user of one or more product showcase events that showcased the product. To illustrate, in certain embodiments, the advertisement trigger event may include a detection of a physical location of a user device (e.g., a mobile phone) associated with the user to be proximate to a physical store premises (e.g., within a predefined distance of a geographic location associated with the store and/or within the structural premises of the store) at which one or more products are offered for purchase.

In response to the detection of the advertisement trigger event associated with the user, the computing system may identify a product that is associated with both the advertisement trigger event and a product showcase event. For example, the computing system may search product data associated with the store and/or retailer (e.g., product inventory data) for a match to a showcased product that has been identified as described above. If a match is found, the computing system may perform one or more advertising operations. For example, the computing system may present an advertisement for the product to the user. Additionally or alternatively, the computing system may notify the user of a product showcase event that showcased the product to the user. For example, the computing system may send a notification message to a user device for presentation by the user device to the user. The notification message may indicate that the identified product was showcased by a particular product showcase event (e.g., by a media content instance) and that the product is available for purchase at a particular retailer and/or location associated with the advertisement trigger event (e.g., at the store to which the user is proximately located). For example, an exemplary notification message may display an image of a dress and indicate, “You may have seen this dress worn by Jennifer Aniston in Friends. The dress is available for purchase at Kohl's for $89.”

By notifying a user of a product showcase event that showcased a product associated with a detected advertisement trigger event, the exemplary advertising systems and methods described herein may leverage product showcase events and any goodwill associated therewith to help generate consumer interest in purchasing the product, particularly when the user is proximate a location when the product may be conveniently purchased. In certain embodiments in which product showcase events are specific to a user, notification of the product showcase events may help the user to recall past exposure of the user to the product, which recollection may further help generate consumer interest in purchasing the product, such as by reminding the user of his or her interest in the product during a past showcasing of the product to the user. These and/or other features and/or benefits provided by the disclosed exemplary systems and methods will be made apparent herein.

As used herein, the term “product” may refer to any product or service that may be purchased and/or used by a consumer. One or more retailers, distributors, providers, or other entities may provide a product for purchase and/or use by a consumer.

The term “product showcase event” may refer to any event that showcases a product such that one or more users who experience the event may be exposed to the product. A product showcase event may provide general exposure of a product to any user who experiences the event or may provide user-specific exposure of a product to a particular user. Examples of product showcase events include, without limitation, a showcasing of a product by media content, a publication of media content that showcases one or more products, a presentation of media content that showcases one or more products, a viewing of media content by a user, a flagging by a user of media content that showcases one or more products, a rating by a user of media content that showcases one or more products, a user-indicated interest in an item associated with media content (e.g., user-indicated interest in an actor, a producer, a director, a theme, a genre, a rating, etc. associated with media content), an interest of a social contact of a user in media content, a showcasing of a product by social media content, a posting or exchange of social media content (e.g., a social networking message such as a Twitter message, a Facebook message, etc.) that showcases one or more products, a posting or exchange of a message (e.g., a text message, and email message, etc.) about one or products, any other content (e.g., web content) that showcases one or more products, and a publication of any other content that showcases one or more products. Exemplary product showcase events will be described in more detail herein.

Content that showcases one or more products may be referred to herein as “product showcase content.” Examples of product showcase content include, without limitation, media content, web content (i.e., website content, webpage content, etc.), social media content, and any other content that may be presented to a user such that one or more products are showcased to the user as a product showcase event.

The terms “media content” and “media content instance” may refer to any media content program, television program, on-demand media program, pay-per-view media program, broadcast media program (e.g., broadcast television program), multicast media program (e.g., multicast television program), narrowcast media program (e.g., narrowcast video-on-demand program), IPTV media content, advertisement, video, movie, audio program, radio program, or any segment, component, or combination of these or other forms of media content that a user may access by way of a media content processing device.

The term “social media content” may refer to content posted to and/or exchanged by way of a social media and/or networking service. For example, social media content may include Facebook content, Twitter content, and/or any other content (e.g., social networking messages) exchanged by way of a social media and/or networking service.

The term “advertisement trigger event” may refer any event predefined to trigger performance of one or more advertising operations, such as an operation that presents an advertisement for a product to the user and/or an operation that notifies the user of one or more product showcase events that showcased the product. Examples of advertisement trigger events include, without limitation, a geographic proximity of a physical location of a user to a predetermined physical location (e.g., a geographic proximity of a user device associated with the user to a store, mall, airport, or other physical location), a user accessing of a predetermined network location (e.g., a user device associated with the user accessing a specific Uniform Resource Locator (“URL”) address, website, webpage, Internet Protocol (“IP”) address, or other network address), a user device scanning of a barcode or quick code of a product, a search for information about a product (e.g., a keyword search for information about a product), an accessing of media content (e.g., playback, download, or streaming of a media content instance), a user device uploading a product image and/or product information for a product, a user request for a product or information about a product, a receipt and/or providing of information (e.g., an advertisement) about a product, and any other event predefined to trigger one or more advertising operations. Exemplary advertisement trigger events will be described in more detail herein.

Examples of product showcase based advertising systems and methods will now be described in reference to the accompanying drawings.

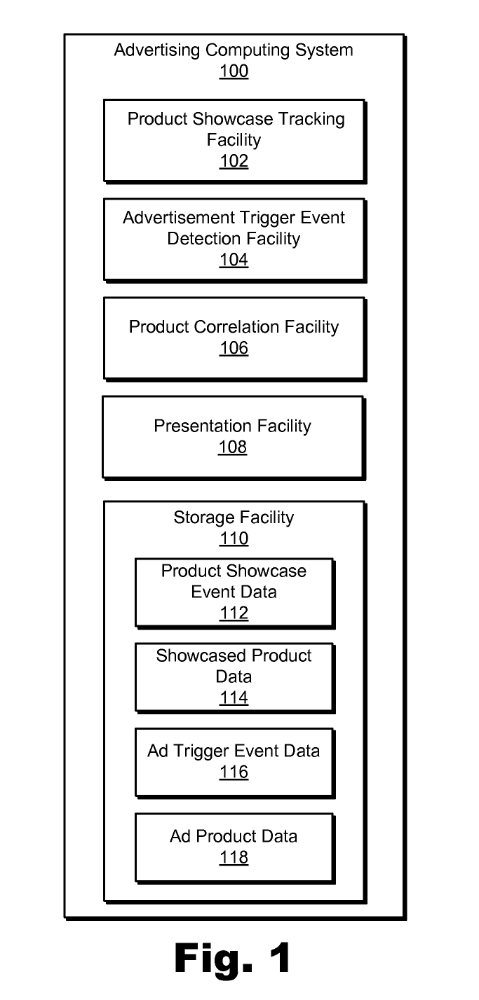

FIG. 1 illustrates an exemplary advertising computing system 100 (“computing system 100” or “system 100”). As shown, system 100 may include, without limitation, a product showcase event tracking facility 102 (“tracking facility 102”), an advertisement trigger event detection facility 104 (“detection facility 104”), a product correlation facility 106 (“correlation facility 106”), a presentation facility 108, and a storage facility 110 selectively and communicatively coupled to one another. Facilities 102-110 may communicate with one another using any suitable data communication technologies. It will be recognized that although facilities 102-110 are shown to be separate facilities in FIG. 1, any of facilities 102-110 may be combined into fewer facilities, such as into a single facility, or divided into more facilities as may serve a particular implementation.

Storage facility 110 may be configured to store and/or maintain data generated and/or used by any of facilities 102-108. For example, storage facility 110 may maintain product showcase event data 112 representative of one or more product showcase events, showcased product data 114 representative of one or more products showcased by one or more product showcase events and relationships between the showcased products and the product showcase events, advertisement trigger event data 116 representative of one or more advertisement trigger events, and advertisement product data 118 representative of one or more products associated with the advertisement trigger events and relationships between the products and the advertisement trigger events. Examples of product showcase event data 112, showcased product data 114, advertisement trigger event data 116, and advertisement product data 118 are described herein. It will be recognized that storage facility 110 may maintain additional or alternative data as may serve a particular implementation.

Tracking facility 102 may be configured to track product showcase events that showcase one or more products. Tracking facility 102 may perform the tracking in any suitable way. In certain embodiments, for example, tracking facility 102 may be configured to detect and log product showcase events. Tracking facility 102 may maintain data representative of a log of product showcase events in storage facility 110 as product showcase event data 112 such that the log is available for access and use by one or more of the facilities 102-108 of system 100.

Tracking facility 102 may be configured to track product showcase events that may generally expose one or more products to one or more users. For example, tracking facility 102 may detect publications of product showcase content for access by one or more users who may access the content and be exposed to one or more products showcased by the content. For instance, tracking facility 102 may detect events that distribute, post, and otherwise publish product showcase content for general user access. In response to the detected product showcase events, tracking facility 102 may log the events and/or the product showcase content associated with the events.

To illustrate, in certain embodiments, tracking facility 102 may be configured to detect publications of media content, which publications may include a release of media content to the public (e.g., release of a movie), uploading of media content to a media content distribution or sharing service, distribution of media content for general user access, and/or any other publication of media content that may expose the media content to one or more users who access the media content. As another example, in certain embodiments, tracking facility 102 may be configured to detect and/or mine postings of social media content for public access (e.g., postings of social network messages) and/or postings of web content that showcase one or more products. This type of tracking may be referred to as general product showcase event tracking and may be performed by tracking facility 102 to track general product showcase events related to media content and/or other content that showcases one or more products, without specificity to a particular recipient user.

Additionally or alternatively, tracking facility 102 may be configured to track product showcase events with specificity to a particular recipient user. For example, tracking facility 102 may detect events related to providing product showcase content (e.g., media content, social media content, web content, and/or other content) to a particular user. In response to the detected events, tracking facility 102 may log the events as associated with the particular user (e.g., as product showcase events that have exposed the user to one or more products). Such a log may be referred to as a “product showcase history” and/or “product exposure history” of the user. This type of tracking may be referred to as user-specific product showcase event tracking. As described herein, user-specific product showcase event tracking may facilitate system 100 providing notifications of product showcase events to a user in a personalized manner, such as based on a tracked content viewing history of the user (e.g., a media content viewing history of the user).

Tracking facility 102 may be configured to perform the user-specific product showcase event tracking in any suitable way. In some embodiments, for example, tracking facility 102 may be configured to detect when a user device associated with a particular user (e.g., a user device owned by, registered to, and/or operated by the user) accesses and/or presents product showcase content for experiencing by the user. For instance, tracking facility 102 may detect that a user device such as a set-top box (“STB”), digital video recorder (“DVR”), personal computer, tablet computer, personal media player device, or mobile phone device associated with the user accesses and/or presents (e.g., plays back, displays, etc.) media content that showcases one or more products for experiencing by the user. Additionally or alternatively, in some embodiments, tracking facility 102 may be configured to detect when a network device (e.g., a server device, a media content provider device, etc.) distributes (e.g., streams, downloads, transfers, etc.) product showcase content to a user device associated with the user.

Accordingly, tracking facility 102 may create and maintain a log of product showcase events specific to the particular user. The log may include data representative of product showcase events specific to the user, such as data representative of media content that showcases one or more products and that has been provided and/or presented for experiencing by the particular user.

In certain embodiments, tracking facility 102 may be configured to perform one or more of the tracking operations described herein automatically as part of a background process and/or without user intervention. For example, tracking facility 102 may automatically generate and maintain a log indicating a media content viewing history of a user. Such automatic tracking of product showcase events may be performed by tracking facility 102 based on predefined settings such as default settings defined by an operator of system 100 and/or custom settings defined by an end user of a service provided by the exemplary systems and/or methods described herein.

Tracking facility 102 may be configured to additionally or alternatively perform one or more tracking operations based on and/or in response to user input provided by an end user of a service provided by the exemplary systems and/or method described herein. To illustrate, in certain embodiments, tracking facility 102 may be configured to track product showcase events flagged by a user as being of interest to the user. For example, the user may provide input to indicate that a particular product showcase event is of interest to the user. To illustrate, during a presentation of a media content instance, a user may provide input to flag the presentation of the media content instance as a product showcase event that is of interest to the user. The user input may be in any suitable form and provided by the user in any suitable way. For example, the user may select a “like” button or option to indicate that the user likes the media content instance, or the user may select a “flag” button or option to indicate that the user is interested in the media content instance and/or one or more products showcased by the media content instance.

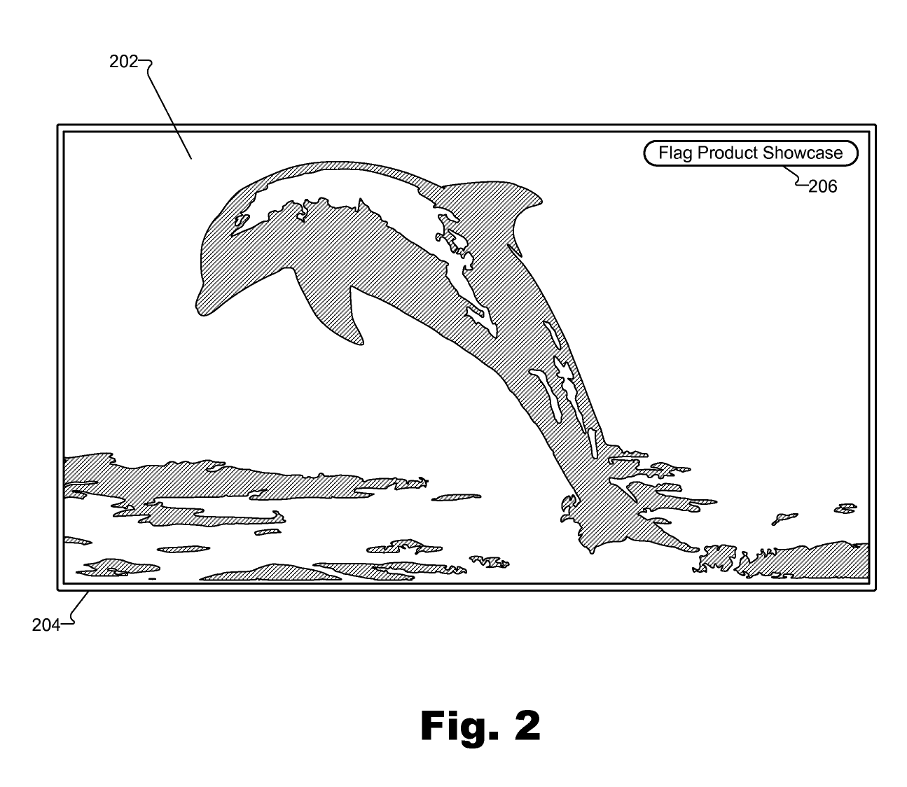

FIG. 2 illustrates a presentation of a media content instance on a display screen 202 of a user device 204. During the presentation, a user may view or otherwise be exposed to a product showcased by the media content instance and in which the user is interested. For example, the media content instance may showcase a theme park, a dolphin show, or an interactive dolphin experience, and the user may be interested in one or more of these showcased products. The user may provide input to indicate the user's interest in the media content instance and/or one or more of the products showcased by the media content instance, such as by selecting a “flag product showcase” option 206. Tracking facility 102 may detect the flagging of the media content instance as an indication by the user that the user is interested in one or more products showcased by the media content instance, and may log data representative of the media content instance and/or the presentation of the media content instance in a log of product showcase events in which the user is interested.

In certain embodiments, tracking facility 102 may be configured to log data indicating a particular segment of a media content instance in which the user is interested. For example, tracking facility 102 may determine a playback position at which the user selected option 206 and identify a segment of the media content instance based on the playback position. For instance, tracking facility 102 may identify a segment that extends from a starting playback time that temporally precedes (e.g., by a predetermined length of time) the playback time at which the user selects option 206 to an ending playback time that is approximately equal to or temporally follows (e.g., by a predetermined length of time) the playback time at which the user selects option 206. This example is illustrative only. A segment may be determined in any suitable way in response to the user selection of option 206. By identifying and logging data for a particular segment of the media content instance, tracking facility 102 may narrow down the products in which the user may be interested to the products showcased by the particular segment.

Tracking facility 102 may be configured to identify one or more products showcased by tracked product showcase events. Tracking facility 102 may identify the products showcased by the tracked product showcase events in any suitable way. In certain embodiments, for example, tracking facility 102 may access data representative of products showcased by media content and relationships between showcased products and the media content (e.g., relationships indicating which media content instances showcase which products). Such data may be referred to as showcased product data 114 and may be stored in storage facility 110. In certain examples, tracking facility 102 may generate and maintain showcased product data 114. In other examples, tracking facility 102 may be configured to access showcased product data 114 from a service provider providing access to the showcased product data 114 as a service. For instance, a service provider may maintain and provide, as a service, showcased product data 114 that specifies media content instances, products showcased by the media content instances, and relationships between the showcased products and the media content instances.

In certain embodiments, tracking facility 102 may be configured to identify showcased products that are of interest to the user based on user input provided by the user. To this end, tracking facility 102 may provide one or more tools configured to facilitate the user providing additional input to indicate a particular product showcased by a media content instance and in which the user is interested. For example, in response to a user selection of option 206, tracking facility 102 may prompt the user to provide input to indicate a particular showcased product in which the user is interested. To this end, in certain embodiments, tracking facility 102 may identify, in response to the user selection of option 206, one or more products showcased by the media content instance, such as by querying showcased product data 114 for the media content instance to identify products showcased by the media content instance, and present data representative of a list of the showcased products such that the user may select, from the list, a particular showcased product in which the user is interested.

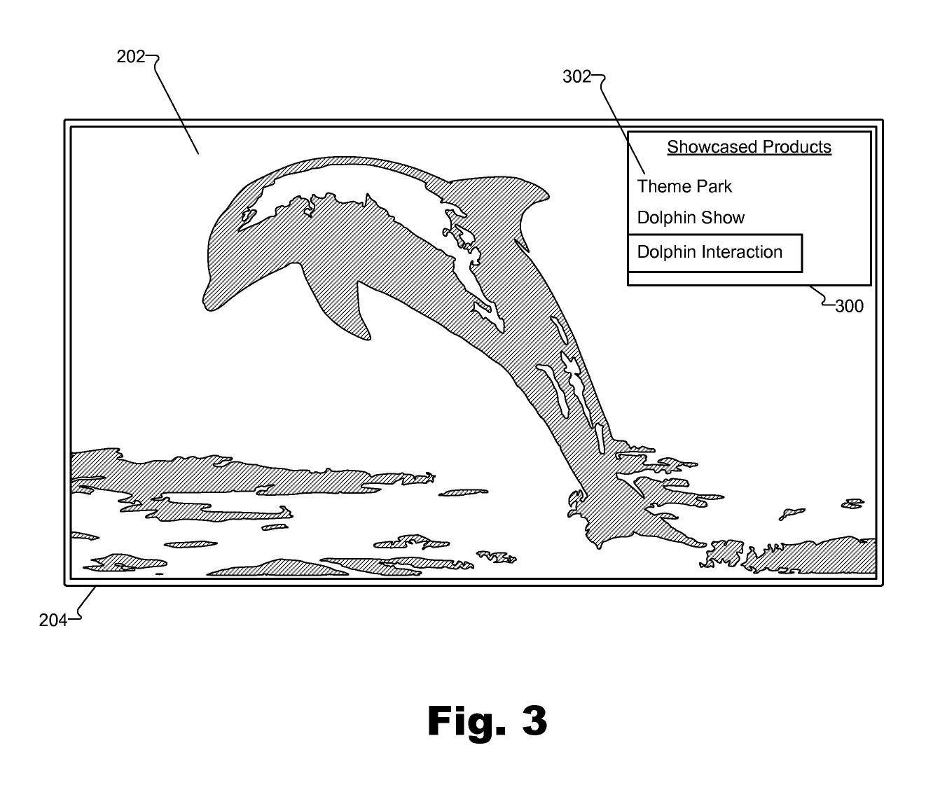

To illustrate, FIG. 3 shows a graphical user interface (“GUI”) 300 that may be displayed on the display screen 202 of user device 204 in response to a user selection of option 206. As shown, GUI 300 may include a list 302 of products showcased by a media content instance flagged by the user selecting option 206. The products in the list 302 may represent products that span the entirety of the media content instance or only products that are showcased temporally proximate to a playback time of the user selection of option 206 (e.g., only products that are showcased within a segment of the media content instance that is proximate to the playback time at which the user selected option 206).

The user may provide input to select, from list 302, a particular showcased product in which the user is interested. Tracking facility 102 may detect the selection and flag the showcased product as being of interest to the user. For example, tracking facility 102 may add data representative of the showcased product, as well as data representative of the product showcase event that showcased the product to showcased product data 114 stored in storage facility 110.

Tracking facility 102 may be configured to track product showcase events in any suitable way, including in real time as the events occur and/or by mining data representative of the events to identify the product showcase events. For example, tracking facility 102 may be configured to track live presentations of media content and/or exchange of messages that showcase products. As another example, tracking facility 102 may be configured to mine data representative of media content metadata, social content, or other program showcase content to identify program showcase events.

Tracking facility 102 may be configured to facilitate user generation of product showcase events, such as when tracking facility 102 fails to locate a product showcase event for a product. For example, tracking facility 102 may post a message to a social networking community to request and/or prompt members of the community to provide information about the product.

Data (e.g., product showcase event data 112 and showcased product data 114) representative of tracked product showcase events and/or products showcased by the product showcase events may be used by system 100 to leverage product showcase events in one or more advertising operations, which may help increase the effectiveness of the advertising operations and/or assist a user in recalling interest in a showcased product and/or product showcase event. System 100 may be configured to perform such advertising operations in response to a detected advertisement trigger event.

As mentioned, an advertisement trigger event may include any event predefined to trigger performance of one or more advertising operations, such as an operation that presents an advertisement for a product to a user and/or an operation that notifies a user of one or more product showcase events that showcased the product. Detection facility 104 may be configured to detect an advertisement trigger event associated with a user. Detection facility 104 may be configured to detect a predefined trigger event in any suitable way. Examples of advertisement trigger events and detection of the advertisement trigger events will now be described.

In certain embodiments, an advertisement trigger event may include a geographic proximity of a user to a predetermined physical location. Detection facility 104 may detect such a geographic proximity in any suitable way. For example, detection facility 104 may detect a physical location of a user device associated with the user and compare the physical location of the user device to one or more predetermined physical locations to determine whether the user device is geographically proximate to any of the predetermined physical locations (e.g., within a predefined distance of a predetermined physical location). Any suitable location detection technologies may be used and/or leveraged by detection facility 104 to aid in this determination, including Global Positioning System (“GPS”) and/or terrestrial triangulation technologies. Accordingly, detection facility 104 may detect when a user of a user device is located proximate to a predetermined physical location.

A predetermined physical location may be associated with one or more products. For example, a predetermined physical location may be associated with a physical location of a product and/or a product provider. Examples of such physical locations include, without limitation, a brick and mortar store, an airport, a mall, an arena, a theater, a theme park, and any other physical location at which a product provider provides products for purchase, use, or access by a consumer. Accordingly, detection facility 104 may detect when a user is geographically proximate to a location associated with a product and/or product provider.

In certain embodiments, an advertisement trigger event may include a user accessing a predetermined network location. Detection facility 104 may be configured to detect a user accessing a predetermined network location in any suitable way. For example, detection facility 104 may be configured to detect that a user device associated with a user accesses a predetermined network location (e.g., the user device requests access to and/or accesses the predetermined network location). Additionally or alternatively, detection facility 104 may be configured to detect when a network device receives a request from the user device and/or provides the user device with access to the predetermined network location.

A predetermined network location may be associated with one or more products and/or product providers. For example, a predetermined network location may be associated with a network location of a product provider, such as a URL address, website, webpage, IP address, and any other network address or location associated with a product provider. As another example, a predetermined network location may be associated with information about one or more products and/or a provider of the product(s). For instance, a predetermined network location may include a website or webpage that, when accessed and presented to a user, presents information about one or more products and/or product providers (e.g., banner ads and/or other advertisements included in a website or webpage). Accordingly, detection facility 104 may be configured to detect when a user requests access to and/or accesses a network location that contains online content related to a product and/or a product provider.

In certain embodiments, an advertisement trigger event may include a user request for a product or information about a product. For example, an advertisement trigger event may include a request for a keyword search that includes one or more keywords provided by a user and related to a product and/or product provider. As another example, an advertisement trigger event may include a user device scanning a barcode, a quick code, or an image associated with a product (e.g., an image of the product, an image of printed information about the product, etc.).

Detection facility 104 may be configured to detect that a user device associated with a user is requesting a product or information about a product in any suitable way. For example, detection facility 104 may be configured to detect when the user device generates and/or sends a request for a product or information about the product to another computing device. Additionally or alternatively, detection facility 104 may be configured to detect when a network device receives the request for the product or information about the product from the user device and/or provides the user device with access to the product or information about the product. Accordingly, detection facility 104 may detect when a user requests and/or is exposed to information about a particular product or product provider.

The above-described examples of advertisement trigger events and detection of the advertisement trigger events are illustrative only. Detection facility 104 may be configured to detect any advertisement trigger event that has been predefined to a trigger performance of one or more advertising operations, such as an operation that presents an advertisement for a product to a user and/or an operation that notifies a user of one or more product showcase events that showcased the product.

Data representative of detected advertisement trigger events and/or data defining advertisement trigger events and/or conditions for detecting one or more advertisement trigger events may be stored as advertisement trigger event data 116 in storage facility 110. Data representative of products and/or product providers associated with advertisement trigger events may be stored as advertisement product data 118 in storage facility 110. Advertisement product data 118 may be maintained by system 100 and/or accessed by system 100 from an external source, such as from one or more computing devices associated with one or more product providers. As described herein, advertisement trigger event data 116 and/or advertisement product data 118 may be used by system 100 to identify one or more products associated with a detected advertisement trigger event.

In response to a detection of an advertisement trigger event, system 100 may perform one or more operations. In certain embodiments, for example, system 100 may identify a product associated with both the advertisement trigger event and a product showcase event and notify the user associated with the advertisement trigger event of the product showcase event that showcased the product. System 100 may also facilitate user access to the product and/or the product showcase event that showcased the product.

Correlation facility 106 may be configured to correlate products showcased by product showcase events with products associated with a detected advertisement trigger event to identify any products that are associated with both a product showcase event and the detected advertisement trigger event. A product that is identified by correlation facility 106 to be associated with both a product showcase event and an advertisement trigger event may be referred to as a “matching product.” Correlation facility 106 may be further configured to identify one or more product showcase events that showcase a matching product.

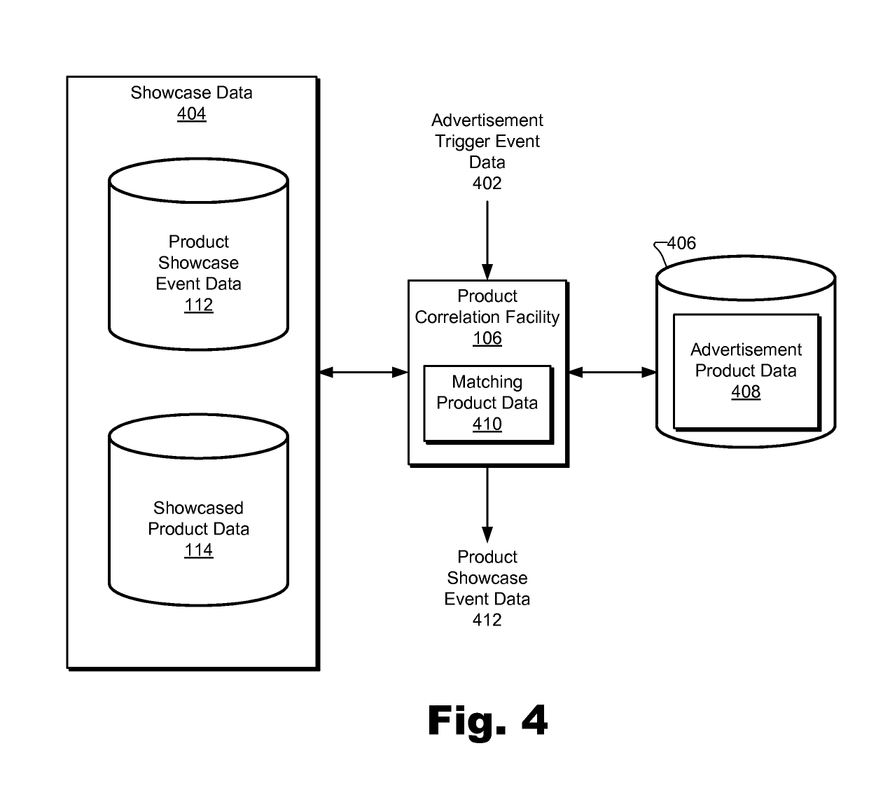

To illustrate, FIG. 4 shows an exemplary product correlation that may be performed by correlation facility 106. As shown, correlation facility 106 may receive advertisement trigger event data 402 (e.g., from detection facility 104 and/or storage facility 110), which data 402 may indicate a detection of an advertisement trigger event by detection facility 104. In response, correlation facility 106 may identify one or more matching products that are associated with both the advertisement trigger event represented by data 402 and one or more product showcase events.

In certain embodiments, correlation facility 106 may perform a forward lookup to identify matching products. In a forward lookup, correlation facility 106 first accesses showcase data 404 representative of product showcase events and/or products that have been determined by tracking facility 102 to be of interest to a user in order to identify one or more products of interest to the user. Correlation facility 106 may then use the identified products of interest to determine any matching products associated with a detected advertisement trigger event. Examples of forward lookup by correlation facility 106 will now be described.

In some examples, correlation facility 106 may access product showcase event data 112 to determine one or more product showcase events associated with the user. Correlation facility 106 may then use the identified product showcase events to query showcased product data 114 to determine one or more products showcased to the user by the product showcase events. In other examples, correlation facility 106 may access showcased product data 114, without having to first access product showcase event data 112, to determine one or more products showcased to the user by product showcase events tracked by tracking facility 102.

Correlation facility 106 may use the products identified from showcased product data 114 to lookup any matching products associated with the advertisement trigger event. For example, correlation facility 106 may determine whether advertisement trigger event data 402 indicates any matching products. As another example, correlation facility 106 may use the identified products of interest to the user to query a data store 406 of advertisement product data 408 for any matching products. To this end, correlation facility 106 may use information included in advertisement trigger event data 402 to identify data store 406 as being related to the detected advertisement trigger event. Correlation facility 106 may also use advertisement trigger event data 402 to determine a location of data store 406 such that correlation facility 106 may send one or more queries for matching products to data store 406.

To illustrate, correlation facility 106 may determine, from advertisement trigger event data 402, a particular product provider and/or data store 406 associated with the advertisement trigger event. From this determination, correlation facility 106 may determine a location to which to send a query. For instance, correlation facility 106 may determine to send the query to data store 406 that stores advertisement product data 408 representing of one or more products associated with the advertisement trigger event (e.g., one or more products offered for purchase or use by a product provider and/or at a location such as a physical or online store associated with the advertisement trigger event).

Accordingly, correlation facility 106 may query data store 406, which may be maintained by a provider of products and made available for access by correlation facility 106 by agreement between the product provider and an operator of system 100, for any products that match the products identified from showcased product data 114. If any matching products are found in advertisement product data 408, correlation facility 106 may generate matching product data 410 that represents the matching products.

Correlation facility 106 may use the matching product data 410 to identify one or more product showcase events that showcased the matching products to the user. For example, correlation facility 106 may use the matching product data 410 to query showcase data 404 for any product showcase events that showcased the matching products. To this end, correlation facility 106 may submit a query for a product and receive, in response to the query, any product showcase event data representing one or more product showcase events that showcased the product. The product showcase event data received in response to the query is represented as product showcase event data 412 in FIG. 4. As shown, correlation facility 106 may output the product showcase event data 412 (e.g., to presentation facility 108).

As mentioned, the above-described exemplary product correlation that uses showcase data 404 to query advertisement product data 408 for matching products may be referred to as a “forward lookup” product correlation. In certain alternative embodiments, correlation facility 106 may be configured to perform a “reverse lookup” product correlation in which correlation facility 106 may use data associated with a detected advertisement trigger event to query showcase data 404 to identify any products associated with both the detected advertisement trigger event and product showcase events.

In some examples, correlation facility 106 may determine, from advertisement trigger event data 402, one or more products associated with the detected advertisement trigger event. In other examples, correlation facility 106 may use advertisement trigger event data 402 to identify data store 406 and query advertisement product data 408 for any products related to the advertisement trigger event represented by advertisement trigger event data 402. Correlation facility 106 may determine, based on the response to the query, any products associated with the detected advertisement trigger event.

Correlation facility 106 may then use any identified products associated with the advertisement trigger event to query showcase data 404 for any matching products. If a match product is found, correlation facility 106 may generate and use matching product data 410 to determine, from the showcase data 404, any product showcase events that showcased the matching products. Correlation facility 106 may then output (e.g., to presentation facility 108) product showcase event data 412 that represents one or more product showcase events that showcased the matching product.

Presentation facility 108 may be configured to provide a user with access to one or more product advertisements and/or notification messages notifying the user of one or more product showcase events that showcased one or more products. Presentation facility 108 may be further configured to provide the user with access to one or more product showcase events that showcased one or more products.

To illustrate, presentation facility 108 may access (e.g., from correlation facility 106) product showcase event data 412 representing one or more product showcase events that showcased a product identified by correlation facility 106 to match a product associated with a detected advertisement trigger event. Presentation facility 108 may be configured to notify the user of the product showcase events, such as by sending a notification message about the product showcase events to a user device associated with the user for presentation to the user by the user device. In certain examples, the notification message may be provided in conjunction with an advertisement for the matching product showcased by the product showcase events.

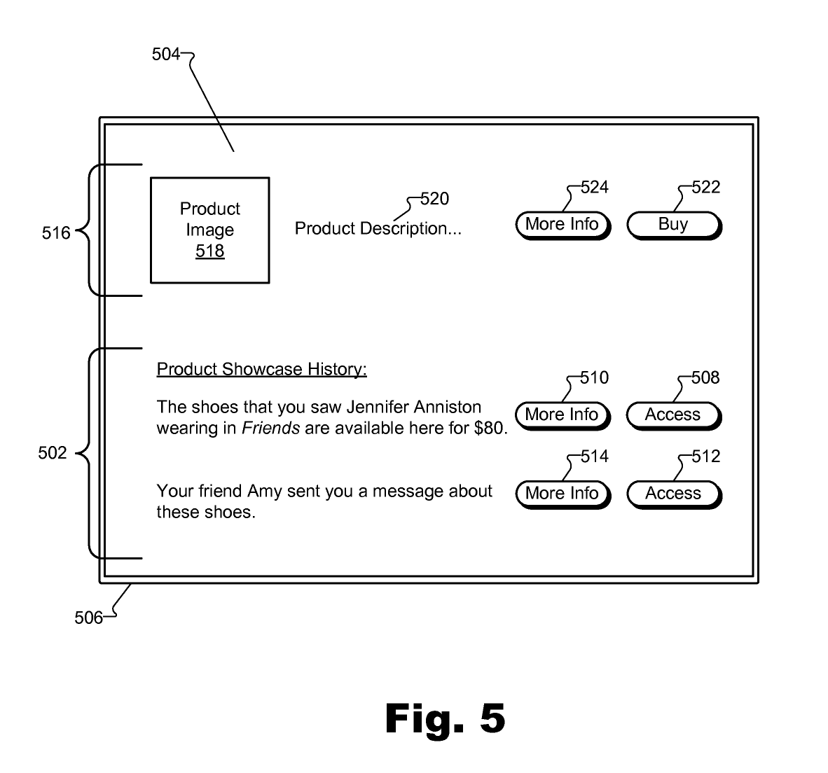

FIG. 5 illustrates a presentation of an exemplary notification message 502 on a display screen 504 of a user device 506. As shown, notification message 502 may provide information to a user about product showcase events that showcased a product to the user. In the illustrated example, notification message 502 provides information about a first product showcase event in the form of a television program that showcased the product. As shown, notification message 502 indicates to the user that the user saw the product showcased by a particular television program (e.g., a television program known as Friends) and that the product is available for purchase at a particular location (e.g., at a store in which the user is located) for a particular price. In the illustrated example, notification message 502 also provides information about a second product showcase event in the form of a message from a friend that showcased the product. As shown, notification message 502 may indicate to the user that a particular friend (or other social contact) of the user sent the user a message about the product. These particular examples of notification message 502 notifying the user of product showcase events are illustrative only. Other suitable notifications for other product showcase events may be provided in other embodiments.

Notification message 502 may be configured to facilitate user access to one or more product showcase events and/or more information about the product showcase events. For example, notification message 502 may include one or more selectable options that may be selected by the user to access product showcase events and/or more information about the product showcase events. To illustrate, in FIG. 5, notification message 502 includes an option 508 that may be selected by the user to initiate access to the television program or to a segment of the television program known as Friends. In response to a user selection of option 508, presentation facility 108 may access and present the television program or a segment of the television program for experiencing by the user.

System 100 may be configured to access and present a television program or segment of a television program, or any other product showcase event, to a user in any suitable way. For example, system 100 may be configured to communicate with one or more service provider computing devices to access program showcase content. To illustrate, system 100 may be configured to communicate with a video-on-demand (“VOD”) service provider computing device to facilitate access by a user device to video content such as a television program that showcases a product.

As further shown in FIG. 5, notification message 502 may include an option 510 configured to be selected by the user to access more information about the television program known as Friends. In response to a user selection of option 510, presentation facility 108 may access and present more information about the television program. Such information may include, without limitation, time information indicating when the product showcase event occurred (e.g., when the television program or segment of the television program was presented to the user), information about a particular media content service, user device, and/or user device platform associated with the presentation of the television program to the user, television program episode and/or channel information, and/or any other information related to the television program.

Similarly, notification message 502 may include an option 512 configured to be selected by the user to initiate access to the second product showcase event in the form of the message received from a friend. In response to a user selection of option 512, presentation facility 108 may access and present the message to the user. Notification message 502 may further include an option 514 configured to be selected by the user to initiate access to more information about the message. In response to a user selection of option 514, presentation facility 108 may access and present more information about the message, such as time information indicating when the message was sent and/or received, information about a messaging service, social media content service, user device, and/or user device platform used to send and/or receive the message, and any other information related to the message.

In the example illustrated in FIG. 5, notification message 502 is presented in conjunction with an advertisement 516 of the product. As shown, advertisement 516 may include a product image 518 and product description 520. Advertisement 516 may further include an option 522 configured to be selected by the user to purchase the product and an option 524 configured to be selected by the user to access more information about the product and/or a provider of the product. In response to user selection of option 522, presentation facility 108 may perform one or more operations to facilitate a purchase of the product, such as directing the user to a location at which the user may purchase the product. In response to user selection of option 524, presentation facility 108 may provide more information about the product, such as information about locations and/or providers at/through which the user may purchase the product.

By presenting notification message 502 in conjunction with advertisement 516, presentation facility 108 may enhance the effectiveness of advertisement 516 to generate user interest to purchase and/or learn more about the product. For example, notification message 502 may help the user recall past exposure of the user to the product and/or specific information about the past exposure of the user to the product. In some examples, this may help the user recall having interest in the product during showcasing of the product to the user. The information presented in notification message 502 may further leverage any goodwill the user may have toward the product showcase events and/or a source of the product's showcase events, such as any goodwill toward a television program, a celebrity, a social media contact, a content provider, etc. For example, the user may recall seeing Jennifer Aniston wearing a particular pair of shoes in an episode of the television program known as Friends and being interested in the shoes while watching the television program.

In the example illustrated in FIG. 5, notification message 502 provides information about product showcase events that are specifically related to the user and that exposed the user to the product. Additionally or alternatively, a notification message may provide information about general product showcase events that showcased the product but that are not specific to the user and may not have actually exposed the user to the product. For example, a notification message may provide information indicating that a particular celebrity showcased the product (e.g., an image of a photograph of the celebrity showcasing the product), even though the user may not have been associated with the particular product showcase event by the celebrity.

Although not illustrated in FIG. 5, a notification message may provide the user with additional and/or alternative information. For example, a notification message may indicate one or more social contacts of a user who have interest in a product. For instance, a notification message may indicate social contacts who have been exposed to a product by one or more produce showcase events (e.g., social contacts who have been exposed to the product by the same product showcase event that exposed the user to the product), social contacts who have provided input to indicate their interest in the same product and/or product showcase event (e.g., social contacts who have “liked” the product and/or product showcase event), and/or social contacts who have posted social content showcasing the product and/or the product exposure event.

As another example, a notification message may indicate an aggregate number of users of a service provided by the systems and methods described herein who have been exposed to/or indicated interest in a product. For example, a notification message may indicate an aggregate interest level in the product such as by indicating that “twelve other users have expressed interest in this product.”

In certain embodiments, a notification message may separate information about showcased products based on the types of product showcase events that showcased the products. For example, a notification message may present information about product showcase events that have been flagged by a user. These events may be referred to as “user-flagged-type” product showcase events. Separately, the notification message may present information about other types of product showcase events, such as product showcase events that have been identified based on a viewing history of the user and/or on social media content and/or contacts associated with the user. The information about other types of product showcase events may suggest products associated with the other types of product showcase events separately from the information about products showcased by user-flagged product showcase events.

Additional examples of trigger based notifications of product showcase events will now be described. In one example, a user watching a television program (or other media content instance) may see a particular hotel showcased by the television program. System 100 may identify the showcased hotel as being potentially of interest to the user, such as in any of the ways described herein. Subsequently, the user may perform an action that qualifies as an advertisement trigger event. For example, the user may use an Internet search engine to search for hotels or vacation ideas. System 100 may detect this advertisement trigger event, determine that the particular hotel was showcased to the user, and present a notification indicating the showcasing of the hotel to the user for consideration by the user. For example, a notification message indicating that the user saw the particular hotel while watching the television program may be presented to the user in conjunction with the search results. In this or a similar manner, the user may be reminded of his or her interest in the hotel during the showcasing of the hotel to the user, which reminder may help generate user interest to further research the hotel and/or to reserve a room at the hotel.

As another example, a user shopping at a store may see a product in which the user is interested. The user may utilize a user device to scan information about the product, such as by scanning a barcode, a quick code, and/or image of the product. System 100 may detect the scan as an advertisement trigger event and determine one or more product showcase events that showcased the product and notify the user of the one or more product showcase events that showcased the product. For example, system 100 may send a notification message to the user device. The notification message may inform the user of any product showcase events in which celebrities, media content, and/or other content generally showcased the product. Additionally or alternatively, the notification message may inform the user of any product showcase events that are specific to the user and in which the product was showcased specifically to the user. This may help generate user interest in learning more about and/or purchasing the product.

In certain embodiments, system 100 may be configured to provide data generated and/or maintained by system 100 about a product to a party such as a retailer or advertiser of a product. For example, a retailer and/or an advertiser of a product may partner with an operator of system 100 in order to obtain access to information about the product that is generated by system 100. System 100 may then be configured to provide such information about the product to the retailer and/or advertiser, which information may be useful to the retailer and/or advertiser. For instance, the retailer and/or advertiser may use data about an aggregate interest level in a product to streamline inventory for the product. The operator of system 100 may generate revenue through such a partnership by collecting a fee from the retailer and/or advertising in exchange for the data.

In certain embodiments, a retailer and/or advertiser may partner with an operator of system 100 such that system 100 will be configured to promote the retailer, advertiser, and/or an associated product to one or more users of system 100. For example, a retailer and/or an advertiser may partner with the operator and agree to pay a fee in exchange for promotion of the retailer, advertiser, or associated product. Based on this agreement, system 100 may be configured to promote the retailer, advertiser, or associated product, such as by providing information about the retailer, advertiser, or associated product in response to detected advertisement trigger events. To illustrate, the operator may partner with an owner of a store known as Kohl's and promote Kohl's and/or products offered by Kohl's to users of system 100 in response to detected advertisement trigger events.

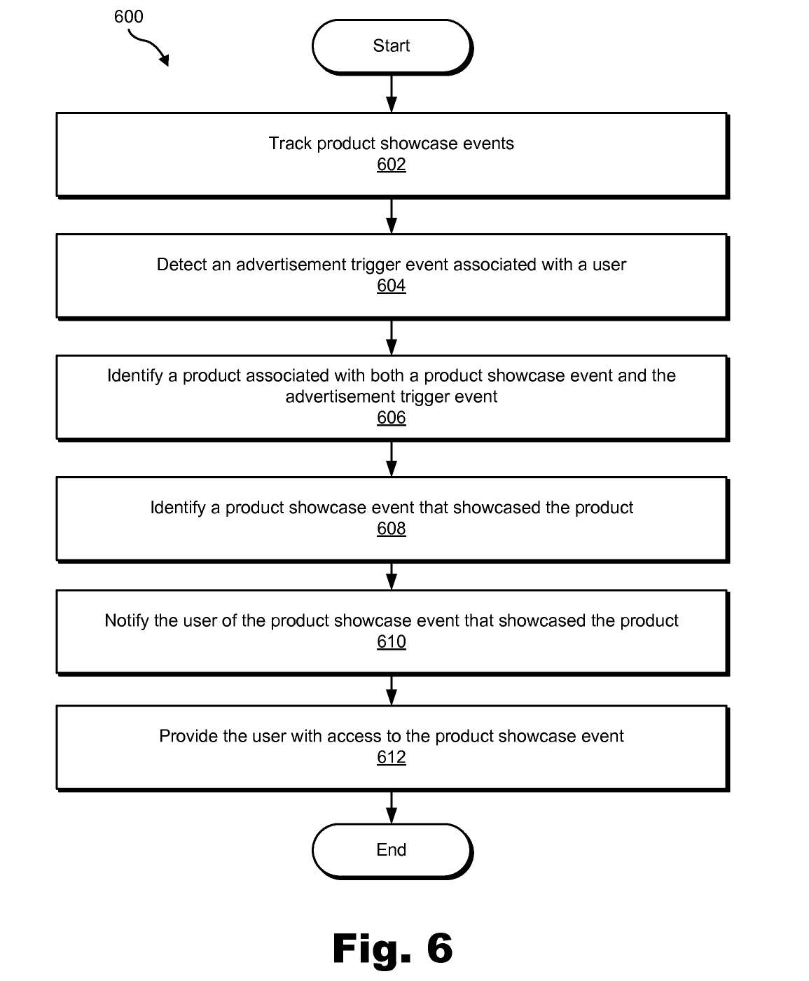

FIG. 6 illustrates an exemplary product showcase based advertising method 600. While FIG. 6 illustrates exemplary steps according to one embodiment, other embodiments may omit, add to, reorder, combine, and/or modify any of the steps shown in FIG. 6. One or more of the steps shown in FIG. 6 may be performed by system 100 and/or any implementation thereof.

In step 602, system 100 tracks product showcase events. Step 602 may be performed in any of the ways described herein.

In step 604, system 100 detects an advertisement trigger event associated with the user. Step 604 may be performed in any of the ways described herein.

In step 606, system 100 identifies a product associated with both a product showcase event and the advertisement trigger event. Step 606 may be performed in any of the ways described herein.

In step 608, system 100 identifies a product showcase event that showcased the product. Step 608 may be performed in any of the ways described herein.

In step 610, system 100 notifies the user of the product showcase event that showcased the product. Step 610 may be performed in any of the ways described herein.

In step 612, system 100 provides the user with access to the product showcase event. Step 612 may be performed in any of the ways described herein.

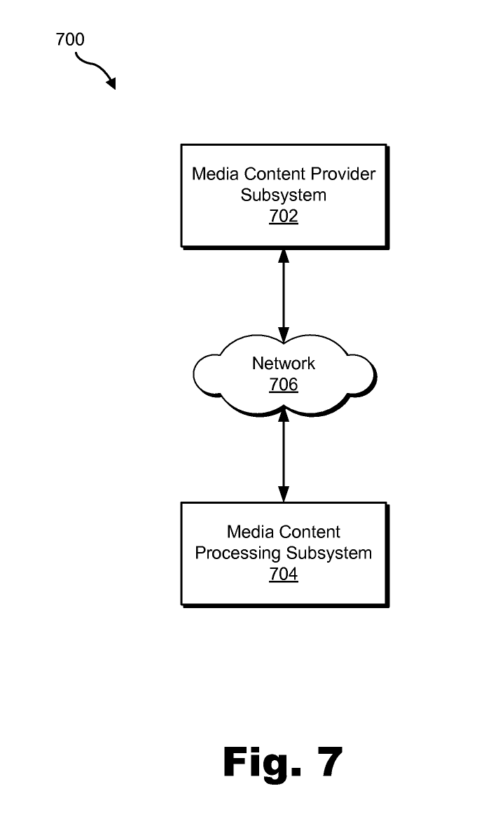

FIG. 7 illustrates an exemplary implementation 700 of system 100 wherein a media content provider subsystem 702 is communicatively coupled to a media content processing subsystem 704 by way of a network 706. Tracking facility 102, detection facility 104, correlation facility 106, presentation facility 108, and storage facility 110 may each be implemented by media content provider subsystem 702 and/or media content processing subsystem 704.

Media content provider subsystem 702 may be associated with a service provider (e.g., a subscriber television service provider, an Internet service provider, a DVR service provider, etc.), a television program provider (e.g., ESPN, NBC, etc.), and/or any other type of media content provider. Accordingly, media content provider subsystem 702 may be configured to provide one or more media content services (e.g., DVR services, television services, video-on-demand services, Internet services, application services, etc.) to media content processing subsystem 704. For example, media content provider subsystem 702 may be configured to manage (e.g., maintain, process, distribute, and/or generate) media content (e.g., television programs, advertisements, etc.) configured to be delivered to media content processing subsystem 704. Media content provider subsystem 702 may be implemented by one or more computing devices as may serve a particular implementation.

Media content processing subsystem 704 may facilitate access by a user to media content (e.g., media content programs and/or advertisements) provided by media content provider subsystem 702. For example, media content processing subsystem 704 may be configured to access and present media content for experiencing by a user. Media content processing subsystem 704 may be further configured to facilitate access by a user to any other product showcase content, such as social media content, messaging content, and/or web content that showcased one or more products.

Media content processing subsystem 704 may include or be implemented by any suitable combination of media content processing or computing devices (“processing devices”). For example, media content processing subsystem 704 may include or be implemented by one or more user devices (i.e., user devices that a user interacts with directly such as set-top box devices, DVR devices, personal computers, mobile devices (e.g., mobile phones and/or tablet computers), personal-digital assistant devices, gaming devices, television devices, etc.).

Media content provider subsystem 702 and media content processing subsystem 704 may communicate with one another using any suitable communication technologies, devices, media, and protocols supportive of data communications, including, but not limited to, socket connections, Ethernet, data bus technologies, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), Time Division Multiple Access (“TDMA”) technologies, Short Message Service (“SMS”), Multimedia Message Service (“MMS”), radio frequency (“RF”) signaling technologies, wireless communication technologies (e.g., Bluetooth, Wi-Fi, etc.), in-band and out-of-band signaling technologies, and other suitable communications technologies.

Media content provider subsystem 702 and media content processing subsystem 704 may communicate using any suitable network. For example, as shown in FIG. 7, media content provider subsystem 702 and media content processing subsystem 704 may be configured to communicate with each other by way of network 706. Network 706 may include one or more networks or types of networks capable of carrying communications and/or data signals between media content provider subsystem 702 and media content processing subsystem 704. For example, network 706 may include, but is not limited to, a cable network, an optical fiber network, a hybrid fiber coax network, a wireless network (e.g., a Wi-Fi and/or mobile telephone network), a satellite network, a wireless broadcast network (e.g., a satellite media broadcasting network or terrestrial broadcasting network), a subscriber television network, a provider-specific network, the Internet, an intranet, a local area network, any other suitable network, and/or any combination or sub-combination of these networks.

In certain embodiments, system 100 may be implemented entirely by media content provider subsystem 702 or by media content processing subsystem 704. In other embodiments, components of system 100 may be distributed across media content provider subsystem 702 and media content processing subsystem 704.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

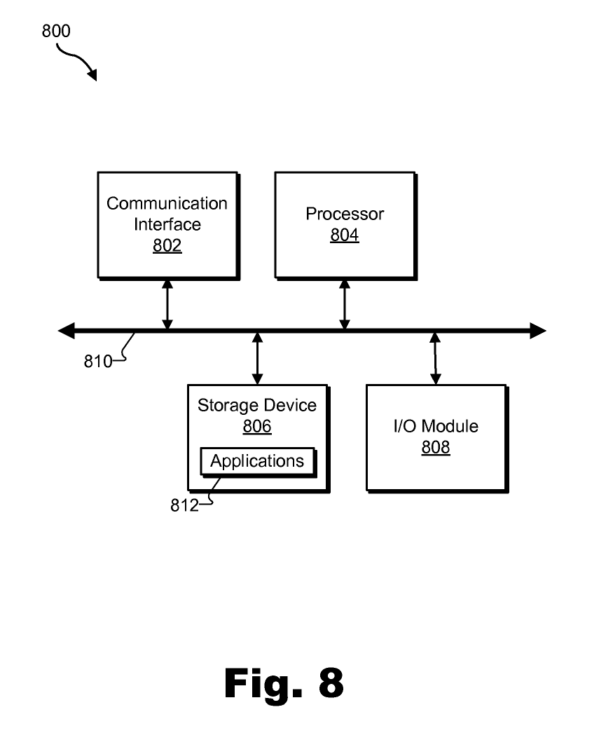

FIG. 8 illustrates an exemplary computing device 800 that may be configured to perform one or more of the processes described herein. As shown in FIG. 8, computing device 800 may include a communication interface 802, a processor 804, a storage device 806, and an input/output (“I/O”) module 808 communicatively connected via a communication infrastructure 810. While an exemplary computing device 800 is shown in FIG. 8, the components illustrated in FIG. 8 are not intended to be limiting. Additional or alternative components may be used in other embodiments. Components of computing device 800 shown in FIG. 8 will now be described in additional detail.

Communication interface 802 may be configured to communicate with one or more computing devices. Examples of communication interface 802 include, without limitation, a wired network interface (such as a network interface card), a wireless network interface (such as a wireless network interface card), a modem, an audio/video connection, and any other suitable interface.

Processor 804 generally represents any type or form of processing unit capable of processing data or interpreting, executing, and/or directing execution of one or more of the instructions, processes, and/or operations described herein. Processor 804 may direct execution of operations in accordance with one or more applications 812 or other computer-executable instructions such as may be stored in storage device 806 or another computer-readable medium.

Storage device 806 may include one or more data storage media, devices, or configurations and may employ any type, form, and combination of data storage media and/or device. For example, storage device 806 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 806. For example, data representative of one or more executable applications 812 configured to direct processor 804 to perform any of the operations described herein may be stored within storage device 806. In some examples, data may be arranged in one or more databases residing within storage device 806.

I/O module 808 may be configured to receive user input and provide user output and may include any hardware, firmware, software, or combination thereof supportive of input and output capabilities. For example, I/O module 808 may include hardware and/or software for capturing user input, including, but not limited to, a keyboard or keypad, a touch screen component (e.g., touch screen display), a receiver (e.g., an RF or infrared receiver), and/or one or more input buttons.

I/O module 808 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 808 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 800. For example, one or more applications 812 residing within storage device 806 may be configured to direct processor 804 to perform one or more processes or functions associated with tracking facility 102, detection facility 104, correlation facility 106, and/or presentation facility 108. Likewise, storage facility 110 may be implemented by or within storage device 806.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
tracking, by a computing system, a plurality of product showcase events that showcase one or more products to a user;
detecting, by the computing system, an advertisement trigger event associated with the user; and
in response to the detecting of the advertisement trigger event:
identifying, by the computing system, a product associated with both the advertisement trigger event and a product showcase event included in the plurality of product showcase events, the product showcase event having showcased the product to the user before the detecting of the advertisement trigger event, and
notifying, by the computing system, the user of the product showcase event that showcased the product.

2. The method of claim 1, wherein the plurality of product showcase events comprises showcasing of the product by at least one of media content, social media content, messaging content, and web content.

3. The method of claim 2, wherein:
the media content comprises at least one of a television program and a movie that showcases the one or more products;
the social media content comprises a social networking message that showcases the one or more products;
the messaging content comprises at least one of a text message and an email message that showcases the one or more products; and
the web content comprises a webpage that showcases the one or more products.

4. The method of claim 1, wherein the tracking of the plurality of product showcase events comprises tracking only the product showcase events that showcase the one or more products to the user and that are flagged by the user as being of interest to the user.

5. The method of claim 1, wherein the tracking of the plurality of product showcase events comprises:
receiving user input indicating the plurality of product showcase events to be of interest to the user; and
logging, in response to the user input, the plurality of product showcase events as being of interest to the user.

6. The method of claim 1, wherein the tracking of the plurality of product showcase events comprises:
receiving user input indicating the plurality of product showcase events to be of interest to the user; and
providing, in response to the user input, a tool configured to facilitate the user indicating a particular product included in each of the one or more products showcased by the plurality of product showcase events that is of interest to the user.

7. The method of claim 1, wherein the detecting of the advertisement trigger event associated with the user comprises one of:
detecting a geographic proximity of the user to a predetermined physical location;
detecting an accessing of a predetermined network location by the user;
detecting a request by the user to access information about the product; and
detecting a providing of information about the product to the user.

8. The method of claim 1, wherein the identifying of the product associated with both the advertisement trigger event and the product showcase event comprises:
determining that the product is showcased by the product showcase event; and
querying advertisement product data associated with the advertisement trigger event for the product to determine that the advertisement product data contains data representative of a match to the product.

9. The method of claim 1, wherein the identifying of the product associated with both the advertisement trigger event and the product showcase event comprises:
determining that the product is associated with the advertisement trigger event; and
querying showcase data representative of the plurality of product showcase events for the product to determine that the showcase data contains data representative of a match to the product.

10. The method of claim 1, wherein the notifying of the user of the product showcase event that showcased the product comprises sending a notification message to a user device associated with the user for presentation to the user by the user device.

11. The method of claim 10, wherein the notification message is configured to facilitate the user accessing at least one of the product showcase event and additional information about the product showcase event.

12. The method of claim 10, further comprising providing, by the computing system, the user with access to the product showcase event through the notification message.

13. The method of claim 10, wherein the notification message is provided to the user device for presentation in conjunction with an advertisement for the product.

14. The method of claim 1, embodied as computer-executable instructions on at least one non-transitory computer-readable medium.

15. A method comprising:
detecting, by a computing system, an advertisement trigger event associated with a user;
identifying, by the computing system, a product associated with the advertisement trigger event;
identifying, by the computing system, a product showcase event that showcased the product before the detecting of the advertisement trigger event; and
notifying, by the computing system, the user of the product showcase event that showcased the product.

16. The method of claim 15, wherein the product showcase event comprises one of a general product showcase event and a user-specific product showcase event specific to the user.

17. The method of claim 15, wherein the product showcase event comprises a showcasing of the product by media content.

18. The method of claim 17, further comprising:
providing, by the computing system, a user selectable option for accessing the media content;
detecting, by the computing system, a user selection of the user selectable option; and
presenting, by the computing system in response to the user selection, the media content for experiencing by the user.

19. The method of claim 18, wherein the presenting of the media content comprises presenting only a segment of the media content within which the product is showcased.

20. The method of claim 15, further comprising tracking, by the computing system before the detecting of the advertisement trigger event, a plurality of product showcase events that showcase the product to the user.

21. The method of claim 15, embodied as computer-executable instructions on at least one non-transitory computer-readable medium.

22. A system comprising:
a product showcase tracking facility configured to track a plurality of product showcase events that showcase one or more products to a user;
an advertisement trigger event detection facility configured to detect an advertisement trigger event associated with the user; and
a product correlation facility communicatively coupled to the product showcase tracking facility and the advertisement trigger event detection facility, the product correlation facility configured to determine, in response to the advertisement trigger event, a product associated with both the advertisement trigger event and a product showcase event included in the plurality of product showcase events; and
a presentation facility communicatively coupled to the product showcase tracking facility, the advertisement trigger event detection facility, and the product correlation facility, the presentation facility configured to notify the user of the product showcase event that showcased the product.
